(19) United States
(12) Patent Application Publication
(10) Pub. No.: US 2009/0200470 A1
(43) Pub. Date: Aug. 13, 2009

(54) Radiation detection apparatus and radiation image capturing system

(75) Inventors: Yasunori Ohta, Yokohama-shi (JP); Naoyuki Nishino, Minami-ashigara-shi (JP); Eiichi Kito, Minami-ashigara-shi (JP); Hiroshi Tamaoki, Odawara-shi (JP); Tatsuo Ilyama, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/320,873

(22) Filed: Feb. 6, 2009

(30) Foreign Application Priority Data
Feb. 7, 2008 (JP) 2008-028063

(51) Int. Cl. G01J 5/00

(52) U.S. Cl. 250/338.1

(57) ABSTRACT

A radiation detection apparatus includes a casing, and a radiation detection device accommodated inside the casing, which detects radiation emitted from a radiation source and having passed through a subject, and converts the radiation into radiation image information. The radiation detection apparatus further includes a data compression circuit, which compresses the radiation image information to thereby create compressed radiation image information, and an infrared light communication unit which converts the compressed radiation image information into an infrared light signal and outputs the infrared light signal.

### BACKGROUND OF THE INVENTION

1. Field of the Invention

The present invention relates to a radiation detection apparatus for irradiating a subject with radiation and capturing a radiation image, as well as to a radiation image capturing system that uses such a radiation detection apparatus.

2. Description of the Related Art

In the medical field, a radiation image capturing apparatus, in which radiation is applied to a subject, and radiation that has passed through the subject is directed to a radiation detection device for capturing a radiation image of the subject, has been widely used.

In this case, as types of radiation detection devices, there are known a conventional radiation film on which a radiation image is exposed and recorded, or a stimulable phosphor panel in which radiation energy is stored as a radiation image in a stimulable phosphor body, and when stimulating light is applied thereto, the radiation image can be read out as stimulated light. In such radiation detection devices, the radiation film in which the radiation image has been recorded is supplied to a developing apparatus where an image developing process is carried out, or the stimulable phosphor panel is supplied to a reading apparatus in which the radiation image is acquired as a visible image by performing a reading process thereon.

On the other hand, in a medical environment such as an operating room or the like, for performing rapid and precise treatments with respect to a patient, it is essential to read out and display the radiation image directly from the radiation detection device. As a radiation detection device capable of responding to such requirements, a radiation detection device has been developed that uses solid state detection elements, which convert radiation directly into electrical signals, or which, after the radiation has been converted into visible light by a scintillator, converts the visible light into electrical signals, which are read out.

In addition, heretofore, various data transmitting methods for transmitting radiation image information to the exterior from the above-mentioned radiation detection device using solid state detecting elements have been proposed. (See, Japanese Laid-Open Patent Publication No. 2004-101195, Japanese Laid-Open Patent Publication No. 2005-296050, Japanese Laid-Open Patent Publication No. 2002-190584, and Japanese Laid-Open Patent Publication No. 2006-267043.)

In the method disclosed in Japanese Laid-Open Patent Publication No. 2004-101195, image data detected by solid state detecting elements is subjected to decimation processing, converted to wireless signals, and transmitted to the exterior. In the method disclosed in Japanese Laid-Open Patent Publication No. 2005-296050, image data detected by solid state detecting elements is subjected to data compression, and is transmitted, through a wireless antenna, to and displayed on a display device for enabling confirmation. In Japanese Laid-Open Patent Publication No. 2002-190584, image data is recorded in a recording medium loaded into an electronic cassette, whereupon the recording medium is ejected from the electronic cassette and loaded into a storage server or the like, thereby supplying the image data to the storage server or the like. In the method disclosed in Japanese Laid-Open Patent Publication No. 2006-267043, radiation image data recorded in a radiation detection device is stored in a detachable image memory, which is then moved to an external apparatus.

Moreover, there has recently been proposed a technique for realizing wireless communications using laser light in the infrared wavelength region, which exhibits an extremely high transmission rate (e.g., 1 Gb/s). (See, “Realization of 1 Gbit/s Transmission Rate Infrared Wireless Communications Used in Portable Telephones,” KDDI R&D Laboratories Inc., [http://www.kddilabs.jp/press/img/83_{—}1.pdf], Jan. 21, 2008 [published online].) If applying this technique, in the transmission and reception of data between electronic devices, even when at least one of the electronic devices is transportable and large amounts of data are transmitted and received, since it is possible for large capacity data to be transmitted and received in a short period of time without requiring cables or the like to be connected between the electronic devices that carry out data transmission and reception, the communication time in wireless communications between existing devices can be significantly shortened, and transmission/reception of large amounts of data between devices, which heretofore could not be envisaged by conventional wireless communications, can be realized. Hence, this technique is likely to be applied to various applications.

However, in the methods disclosed in Japanese Laid-Open Patent Publication No. 2004-101195 and Japanese Laid-Open Patent Publication No. 2005-296050, due to the influence of radio waves between the electronic cassette and the external apparatus, problems may be caused in particular with respect to equipment related to medical procedures. Due to the fact that the strength (power flux density) of radio waves is attenuated inversely proportional to the square of the distance, in order to obtain a fixed gain between two antennas positioned at a given distance, the input power to the antenna must be large. When the input power to the antenna is made large, the power flux density becomes large, and the electrical field intensity, as well as the magnetic field intensity, also becomes large. Accordingly, there is a concern that communication via radio waves between an image capturing room and a control room will adversely affect the electronic cassette and other external devices. Moreover, the frequency of radio waves is defined by electromagnetic waves of 3 kHz or more and less than or equal to 3 THz (terahertz). Further, making the input voltage to the antenna large requires a power source capacity therefore, such that restrictions are placed on the usage time of the battery, and the weight and volume of the electronic cassette is increased, thus undermining the portability of the electronic cassette.

In the methods disclosed in Japanese Laid-Open Patent Publication No. 2002-190584 and Japanese Laid-Open Patent Publication No. 2006-267043, problems related to electromagnetic waves can be avoided. However, a large capacity recording medium is needed, leading to an increase in costs. There is also a problem in that the image data cannot be stored quickly in the recording medium.

### SUMMARY OF THE INVENTION

The present invention, taking into consideration the above-mentioned problems, has the object of providing a radiation detection apparatus and radiation image capturing system, which excels in terms of portability, wherein adverse effects of radio waves are not incurred, and required image information can be swiftly acquired and confirmed.

A radiation detection apparatus according to a first aspect of the present invention includes a casing, and a radiation detection device accommodated inside the casing, which detects radiation emitted from a radiation source and having passed through a subject, and converts. the radiation into radiation image information. The invention further comprises a data compression circuit, which compresses the radiation image information to thereby create compressed radiation image information, and an infrared light communication unit, which converts the compressed radiation image information into an infrared light signal and outputs the infrared light signal.

A radiation image capturing system according to a second aspect of the present invention has a radiation detection apparatus including a casing, a radiation detection device accommodated inside the casing, which detects radiation emitted from a radiation source and having passed through a subject, and converts the radiation into radiation image information, and an electronic circuit accommodated inside the casing. The radiation detection apparatus comprises a data compression circuit, which compresses the radiation image information to thereby create compressed radiation image information, and an infrared light communication unit, which converts the compressed radiation image information into an infrared light signal and outputs the infrared light signal. The radiation image capturing system also includes a signal receiving unit for receiving the infrared light signal output from the infrared light communication unit, and converting the infrared light signal into compressed radiation image information, and a display unit for displaying the compressed radiation image information from the signal receiving unit.

According to the present invention, the adverse influence of radio waves is not imparted to the system, and necessary image information can be quickly acquired and confirmed. Further, the usage time of a battery is not restricted, and the weight and volume of the electronic cassette can be designed to facilitate portability.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a structural view showing a radiation image capturing system;

FIG. 2 is an interior structural view of an electronic cassette;

FIG. 3 is a block diagram of a circuit structure of a radiation detection device accommodated inside the electronic cassette;

FIG. 4 is a schematic block diagram showing primarily the cassette controller of the electronic cassette;

FIG. 5 is a schematic block diagram of the radiation image capturing system;

FIG. 6 is an explanatory view showing one modified example of a transmission state of compressed radiation information; and

FIG. 7 is an explanatory view showing another modified example of a transmission state of compressed radiation information.

### DESCRIPTION OF THE PREFERRED EMBODIMENTS

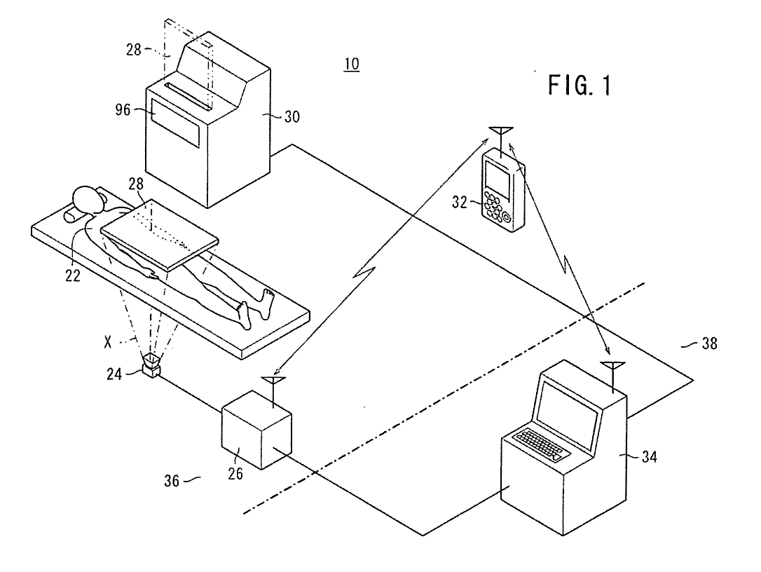

A radiation detection apparatus and a radiation image capturing system in accordance with embodiments of the present invention shall be described below with reference to FIGS. 1 through 7.

As shown in FIG. 1, the radiation image capturing system 10 according to the present embodiment is equipped with a radiation source 24 for irradiating a patient 22 (subject) with radiation X having a given dose according to image capturing conditions, a radiation source control device 26 for controlling the radiation source 24, a radiation detection apparatus (hereinafter referred to as an electronic cassette 28) containing a radiation detection device that detects radiation X having passed through the patient 22, a cradle 30 for carrying out a charging process on the electronic cassette 28, a portable information terminal 32 having an image capturing switch for activating the radiation source 24, which is carried by a technician for confirming conditions including image capturing operations, and a console 34 (control apparatus) for controlling the radiation source control device 26, the electronic cassette 28, the cradle 30 and the portable information terminal 32, as well as performing transmission and reception of necessary information therebetween.

The radiation source 24, the radiation source control device 26 and the cradle 30 are disposed inside an image capturing room 36, whereas the console 34 is located in an operations room 38 outside of the image capturing room 36. Further, necessary information may be transmitted and received between the radiation source control device 26, the portable information terminal 32 and the console 34 by means of wireless communications.

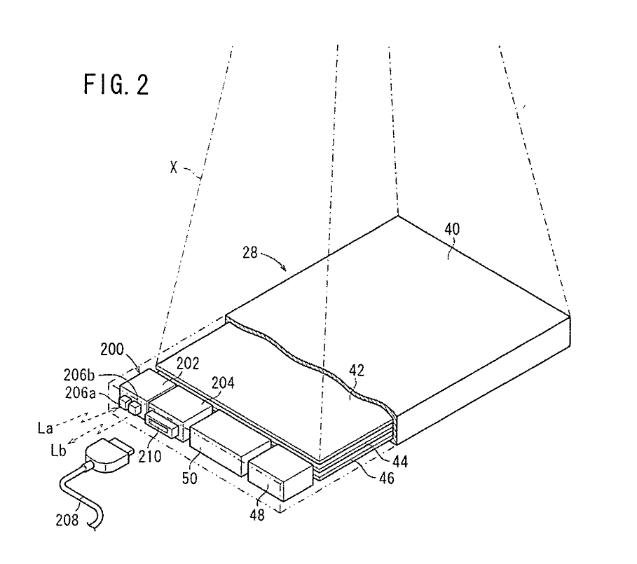

The electronic cassette 28, as shown in FIG. 2, is equipped with a casing 40 made from a material which is permeable to radiation X. Inside of the casing 40, a grid 42 for removing radiation X scattered by the patient 22, a radiation detection device 44 (solid state detector) for detecting radiation X that has passed through the patient 22, and a lead plate 46 for absorbing backscattered radiation X are arranged in this order from a side surface which is irradiated with radiation X.

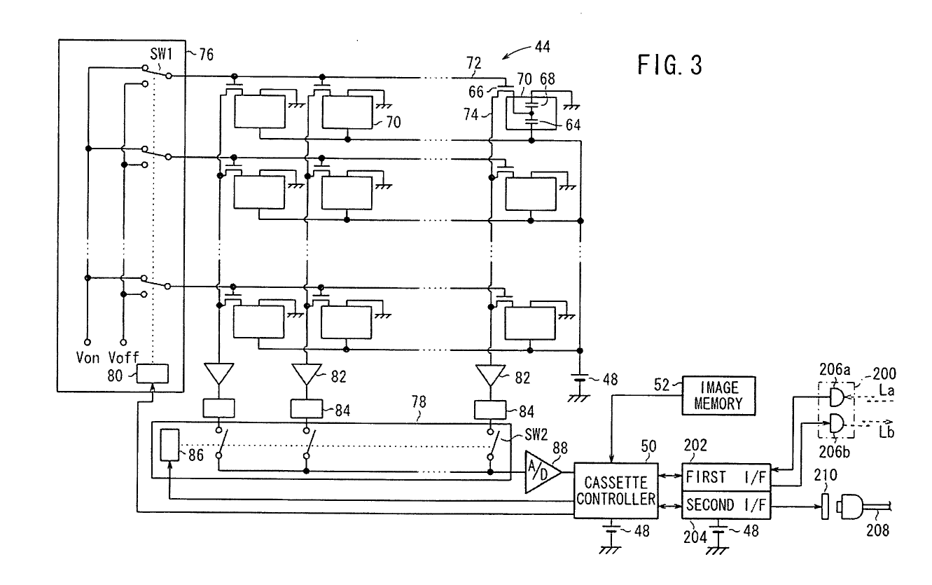

Further, a battery 48, which serves as a power source for the electronic cassette 28, a cassette controller 50 that controls driving of the radiation detection device 44, an image memory 52 (see FIG. 3) for recording therein image information (radiation image information) of radiation X that have been detected by the radiation detection device 44, an infrared light communication unit 200, a first interface 202 (first I/F) for infrared light signals, and a second interface 204 (second I/F) for a cable, are accommodated respectively inside the casing 40. Moreover, in order to avoid damage caused by radiation X to the electronic circuits of the cassette controller 50, the image memory 52, the infrared light communication unit 200, the first interface 202 and the second interface 204, etc., it is preferable for a lead plate or the like to be disposed on surface sides of the casing 40 that are subject to being irradiated with radiation X.

As shown in FIG. 2, on one side surface of the casing 40, the infrared light communication unit 200 is attached. The infrared light communication unit 200 includes an infrared light-receiving element 206a and an infrared light-emitting element 206b. The infrared light-receiving element 206a and the infrared light-emitting element 206b are connected to the first interface 202. Further, on the side surface of the casing 40, a connection terminal 210 is arranged, to which a cable 208 is mounted for facilitating connection to the console 34. The connection terminal 210 is connected to the second interface 204. As the infrared light-emitting element, an LED compliant with IrDA (Infrared Data Association) standards and having a wavelength in the 700 to 2500 nm range, or an LD as disclosed in the aforementioned publication, “Realization of 1 Gbit/s Transmission Rate Infrared Wireless Communications Used in Portable Telephones,” KDDI R&D Laboratories Inc., [http://www.kddilabs.jp/press/img/83_{—}1.pdf], Jan. 21, 2008 [published online], can be used.

As shown in FIG. 3, the radiation detection device 44 includes a structure in which a photoelectric conversion layer 64 made up from an amorphous selenium (a-Se) material or the like, which generates electric charges upon sensing radiation X, is disposed on thin film transistors (TFTs) 66 arrayed in a matrix form. After the generated electric charges are accumulated in storage capacitors 68, the TFTs 66 are successively turned on one line at a time, and the electric charges are read out as image signals. FIG. 3 shows the connected relationship of only one of the TFTs 66 and one pixel (image element) 70 made up from a photoelectric conversion layer 64 and a storage capacitor 68, whereas the structures of other similar pixels 70 have been omitted from illustration for the sake of simplicity. Since when heated to high temperatures, the structure of amorphous selenium changes and the functionality thereof is lowered, amorphous selenium must be used within a prescribed temperature range. Accordingly, it is preferable to provide some means for cooling the radiation detection device 44 inside the electronic cassette 28.

Gate lines 72, which extend in parallel to the direction of the rows, and signal lines 74 which extend in parallel to the direction of the columns, are connected to the TFTs 66, which are connected respectively to each of the pixels 70. Each of the gate lines 72 is connected to a line scanning driver 76, and each of the signal lines 74 is connected to a multiplexer 78 that constitutes a reading circuit.

Control signals Von, Voff that control ON and OFF states of the TFTs 66 arrayed in the direction of the rows, are supplied from the line scanning driver 76 to the gate lines 72. In this case, the line scanning driver 76 comprises a plurality of switches SW1 that switch the gate lines 72 on or off, and a first address decoder 80, which outputs selection signals for selecting one of the switches SW1. Address signals are supplied from the cassette controller 50 to the first address decoder 80.

Further, the signal lines 74 are supplied with electric charges, which are stored in the storage capacitors 68 of each of the pixels 70, through the TFTs 66 arranged in the columns. The electric charges supplied to the signal lines 74 are amplified by amplifiers 82. The amplifiers 82 are connected through respective sample and hold circuits 84 to the multiplexer 78. The multiplexer 78 comprises a plurality of switches SW2 for successively switching between the signal lines 74, and a second address decoder 86 for outputting a selection signal for selecting one of the switches SW2 at a time. The second address decoder 86 is supplied with an address signal from the cassette controller 50. An A/D converter 88 is connected to the multiplexer 78. A radiation image signal is converted by the A/D converter 88 into a digital image signal representing the radiation image information, which is supplied to the cassette controller 50.

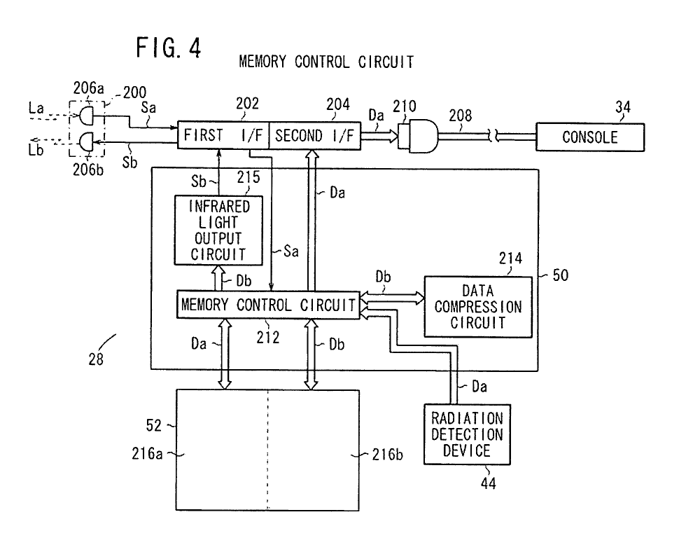

As shown in FIG. 4, the cassette controller 50 includes a memory control circuit 212, a data compression circuit 214, and an infrared light output circuit 215.

The memory control circuit 212 carries out the following processes.

(1) Storing “as is” in a first storage region 216a of the image memory 52 the radiation image information Da supplied to the cassette controller 50 from the radiation detection device 44; and

(2) Supplying the radiation image information Da supplied to the cassette controller 50 to the data compression circuit 214, subjecting the radiation image information Da to data compression processing and creating compressed radiation image information Db, and storing the compressed radiation image information Db in a second storage region 216b of the image memory 52.

The radiation image data Da stored in the first storage region 216a of the image memory 52 is supplied to the connection terminal 210 through the second interface 204 under the control of the cassette controller 50, and is transmitted to the console 34 through the cable 208 connected to the connection terminal 210. Accordingly, data transmission of the radiation image information Da to the console 34 is carried out at a stage when the cable 208 is connected to the electronic cassette 28.

On the other hand, concerning transmission of the compressed radiation image information Db stored in the second storage region 216b of the image memory 52, the system waits until an infrared light transmission request is received.

More specifically, by outputting a signal (i.e., a signal requesting that data be transmitted: transmission request signal La) which indicates a transmission request, by infrared light directed from an external device to the infrared light-receiving element 206a of the electronic cassette 28, the transmission request signal La is converted into an electrical transmission request signal Sa at the infrared light-receiving element, which is then supplied to the memory control circuit 212 through the first interface 202.

Based on input of the transmission request signal Sa, the memory control circuit 212 reads out the compressed radiation image information Db from the second storage region 216b of the image memory 52, and supplies it to the infrared light output circuit 215. The infrared light output circuit 215 converts the input compressed radiation image information Db into infrared light data Sb. The infrared light data Sb is supplied to the infrared light-emitting element 206b through the first interface 202, and is output as an infrared light signal Lb from the infrared light-emitting element 206b. The infrared light signal Lb, which is output from the infrared light-emitting element 206b of the electronic cassette 28, is supplied to the transmission requesting source (i.e., the external device from which the transmission request signal Sa was initially received).

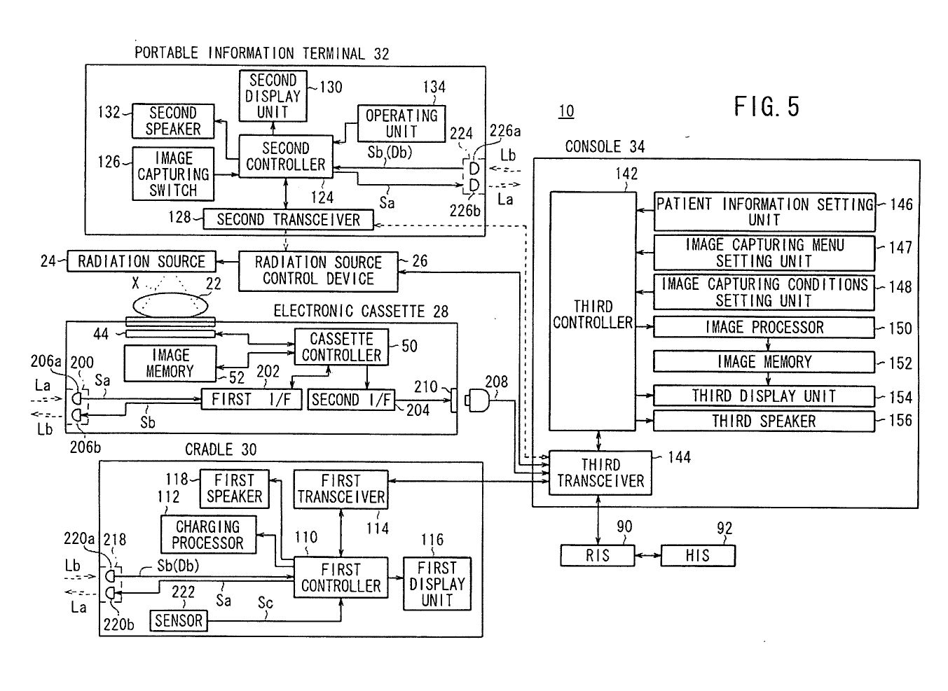

FIG. 5 is a schematic block diagram of the radiation image capturing system 10. The console 34 is connected to a radiology information system (RIS) 90, which generally manages radiation image information handled by the radiological department of a hospital along with other information. Further, the RIS 90 is connected to a hospital information system (HIS) 92, which generally manages medical information in the hospital.

A first controller 110 of the cradle 30 controls a charging processor 112 that carries out a charging process on the battery 48 of the electronic cassette 28. Information received from the console 34 through a first transceiver 114 is displayed on a first display unit 116, and as needed, information may be audibly output by a first speaker 118.

Further, the cradle 30 comprises a first infrared light communication unit 218, which is disposed at a portion facing the infrared light communication unit 200 of the electronic cassette 28 when the electronic cassette 28 is mounted in the cradle 30. The first infrared light communication unit 218 includes a first infrared light-receiving element (signal receiving unit) 220a and a first infrared light-emitting element 220b, wherein the first infrared light-receiving element 220a and the first infrared light-emitting element 220b are connected to the first controller 110 through a non-illustrated infrared light interface. Furthermore, at a portion where the electronic cassette 28 is mounted to carry out charging thereof, a detection sensor 222 is provided, which detects that the electronic cassette 28 has been mounted. A detection signal Sc from the detection sensor 222 is input to the first controller 110.

Accordingly, at a stage when the electronic cassette 28 is mounted in the cradle 30 to carry out charging on the battery of the electronic cassette 28, the detection signal Sc from the detection sensor 222 is input to the first controller 110, and the first controller 110 outputs the transmission request signal Sa based on input of the detection signal Sc. The transmission request signal Sa is supplied to the first infrared light-emitting element 220b through the non-illustrated interface, and is converted into an infrared transmission request signal La and output therefrom, whereupon the infrared transmission request signal La is input to the infrared light-receiving element 206a of the electronic cassette 28.

As a result, the infrared light signal Lb of the compressed radiation image information Db is output from the infrared light-emitting element 206b of the electronic cassette 28 and is directed toward the first infrared light-receiving element 220a of the cradle 30. The infrared light signal Lb is converted into compressed radiation image information (infrared data Sb) in the form of an electrical signal at the first infrared light-receiving element 220a, and is supplied to the first controller 110 as compressed radiation image information Db through a non-illustrated interface. The first controller 110 displays the supplied compressed radiation image information Db as a preview image on the first display unit 116.

Further, a second controller 124 of the portable information terminal 32 supplies the radiation source control device 26 through a second transceiver 128 with an image capturing signal generated by the image capturing switch 126 that drives the radiation source 24. The second controller 124 causes information received from the console 34 through the second transceiver 128 to be displayed on a second display unit 130, and as needed, causes the information to be output audibly by a second speaker 132. Furthermore, the portable information terminal 32 includes an operating unit 134, through which various required information can be set and through which infrared light communications are implemented.

Further, a second infrared light communication unit 224 is provided on a side surface of the portable information terminal 32. The second infrared light communication unit 224 includes a second infrared light-receiving element (signal receiving unit) 226a and a second infrared light-emitting element 226b, wherein the second infrared light-receiving element 226a and the second infrared light-emitting element 226b are connected to the second controller 124 through a non-illustrated infrared light interface.

In addition, the portable information terminal 32 is positioned so that the second infrared light communication unit 224 thereof faces toward the infrared light communication unit 200 of the electronic cassette 28. Further, as a result of infrared light communication being implemented by the operating unit 134, the second controller 124 outputs a transmission request signal Sa. The transmission request signal Sa is supplied to the second infrared light-emitting element 226b through a non-illustrated interface, whereupon the transmission request signal Sa is converted into an infrared light transmission request signal La and output therefrom. The infrared light transmission request signal La is input to the infrared light-receiving element 206a of the electronic cassette 28.

As a result, the infrared light signal Lb of the compressed radiation image information Db is output from the infrared light-emitting element 206b of the electronic cassette 28 and is directed toward the second infrared light-receiving element 226a of the portable information terminal 32. The infrared light signal Lb is converted into compressed radiation image information (infrared data Sb) in the form of an electrical signal at the second infrared light-receiving element 226a, and is supplied to the second controller 124 as compressed radiation image information Db through a non-illustrated interface. The second controller 124 displays the supplied compressed radiation image information Db as a preview image on the second display unit 130.

The console 34 includes a third controller 142, a third transceiver 144 for transmitting and receiving necessary information by wireless communications with respect to the radiation source control device 26, and the portable information terminal 32, a patient information setting unit 146 for setting patient information, an image capturing menu setting unit 147 for selecting and setting, from an image capturing menu, a region to be imaged of the patient 22, an image capturing conditions setting unit 148 for setting required image capturing conditions for capturing an image by the radiation source control device 26, an image processor 150 for carrying out image processing with respect to radiation image information transmitted as data from the electronic cassette 28, an image memory 152 for storing the processed radiation image information, a third display unit 154 for displaying the radiation image information, patient information, the image capturing menu, and the like, and a third speaker 156 for audibly outputting warnings when necessary.

The patient information is defined as information for specifying a patient 22, such as the name and sex of the patient 22, a patient ID number, and the like. The image capturing menu serves as a menu for selecting an image capturing region of the patient 22. As an image capturing region, the head region, a chest region, or regions of the four limbs, etc., of the patient 22 may be considered. The image capturing conditions are conditions for determining a supplied tube voltage, tube current, irradiation time, etc., for irradiating an imaging region of the patient 22 with an appropriate dose of radiation X. Image capturing order information, including the patient information, the image capturing menu and the image capturing conditions, can be set directly by the console 34, or can be supplied externally to the console 34 through the RIS 90.

The radiation image capturing system 10 is basically constructed as described above. Next, operations of the radiation image capturing system 10 shall be described.

When a radiation image of the patient 22 is to be captured, using the patient information setting unit 146 of the console 34, patient information concerning the patient 22 is set, together with setting required image capturing conditions using the image capturing conditions setting unit 148. Further, using the image capturing menu setting unit 147, a desired image capturing region, for example, the head region, a chest region, or a region of the four limbs, etc., is selected and set from the image capturing menu displayed on the third display unit 154.

The set patient information, image capturing conditions and image capturing region are transmitted to the portable information terminal 32 held by the technician and displayed on the second display unit 130 thereof. In this case, the technician confirms the patient information, the image capturing conditions and the image capturing region, which are displayed on the second display unit 130 of the portable information terminal 32, so that desired preparations for capturing the image can be carried out.

Next, the technician places the electronic cassette 28 at a desired image capturing region of the patient 22 as selected from the image capturing menu. When the electronic cassette 28 is placed in a suitable condition with respect to the patient 22, the technician operates the image capturing switch 126 of the portable information terminal 32 in order to carry out capturing of the radiation image. When the image capturing switch 126 is operated, the second controller 124 of the portable information terminal 32 transmits an image capturing initiation signal through the second transceiver 128 to the radiation source control device 26. The radiation source control device 26, which has received the image capturing initiation signal, controls the radiation source 24 in accordance with image capturing conditions supplied beforehand from the console 34, and irradiates the patient with radiation X.

Radiation X that has passed through the patient 22, after scattered rays have been removed by the grid 42 of the electronic cassette 28, irradiate the radiation detection device 44 and are converted into electric signals by the photoelectric conversion layer 64 of each of the pixels 70 making up the radiation detection device 44, which are retained as charges in the storage capacitors 68 (see FIG. 3). Next, the electric charge information that forms the radiation image information of the patient 22 stored in each of the storage capacitors 68 is read out in accordance with address signals, which are supplied from the cassette controller 50 to the line scanning driver 76 and the multiplexer 78.

More specifically, the first address decoder 80 of the line scanning driver 76 outputs a selection signal based on the address signal supplied from the cassette controller 50, thereby selecting one of the switches SW1, and supplies a control signal Von to the gate of the TFT 66 that is connected to a corresponding gate line 72. On the other hand, the second address decoder 86 of the multiplexer 78 outputs a selection signal according to the address signal supplied from the cassette controller 50, and successively switches the switches SW2, whereby the radiation image information, which is formed as electric charge information stored in the storage capacitors 68 of each of the pixels (image elements) 70 that are connected to the gate line 72 selected by the line scanning driver 76, is read out in succession through the signal lines 74.

After the radiation image information read from the storage capacitors 68 of the pixels 70 connected to the selected gate line 72 of the radiation detection device 44 has been amplified by the respective amplifiers 82, the radiation image information is sampled by each of the sample and hold circuits 84, and supplied to the A/D converter 88 through the multiplexer 78 and converted into digital signals. The radiation image information Da having been converted into digital signals is stored in the first storage region 216a of the image memory 52 by the memory control circuit 212 of the cassette controller 50. Furthermore, the radiation image information Da is subjected to data compression by the memory control circuit 212 and the data compression circuit 214, and is stored as compressed radiation image information Db in the second storage region 216b of the image memory 52.

Similarly, the first address decoder 80 of the line scanning driver 76 successively turns on the switches SW1 according to the address signals supplied from the cassette controller 50, and reads out the radiation image information Da, which is made up of charge information stored in the storage capacitors 68 of each of the pixels 70 connected respectively to the gate lines 72 through the signal lines 74, whereupon the radiation image information Da is stored in the first storage region 216a of the image memory 52 through the multiplexer 78 and the A/D converter 88. Furthermore, the compressed radiation image information Db therefrom is stored in the second storage region 216b.

At a stage after the image has been captured, the technician positions the portable information terminal 32, for example, so that the second infrared light communication unit 224 thereof faces toward the infrared light communication unit 200 of the electronic cassette 28. Further, as a result of infrared light communications being effected by the operating unit 134, the compressed radiation image information Db is displayed as a preview image on the second display unit 130. Alternatively, by mounting the electronic cassette 28 in the cradle 30 and carrying out a charging process thereon, the compressed radiation image information Db is displayed as a preview image on the first display unit 116.

As a result, the technician can confirm the compressed radiation image information Db displayed on the first display unit 116 or the second display unit 130, and can determine whether recapturing of the radiation image is necessary or not. In particular, because the amount of information is reduced due to data compression, the compressed radiation image information Db can be displayed quickly.

The radiation image information Da stored in the first storage region 216a of the image memory 52 is transmitted as data to the console 34 through the cassette controller 50 and the interface 54, at a stage when the electronic cassette 28 is connected to the console 34 through the cable 208. After image processing has been implemented by the image processor 150 on the radiation image information Da, which has been transmitted as data to the console 34, the radiation image information Da is stored in the image memory 152 of the console 34 in a state of association with the patient information. Subsequently, the radiation image information Da stored in the image memory 152 is displayed on the third display unit 154.

In this manner, in the radiation image capturing system 10, the radiation image information Da acquired by the electronic cassette 28 is transmitted by infrared communications to the portable information terminal 32 or to the cradle 30, and is displayed on the cradle 30 or the portable information terminal 32. Therefore, there is no need to provide a circuit in the electronic cassette 28 for the purpose of transmitting and receiving radio waves, the adverse influence of radio waves is not imparted, and required image information can be acquired and confirmed in a rapid manner. Further, the usage time of a battery 48 is not restricted, and the weight and volume of the electronic cassette 28 can be designed to facilitate portability.

In the above-mentioned example, the battery 48 is accommodated inside the casing 40 of the electronic cassette 28, so that power is supplied to the radiation detection device 44, the electronic circuits, etc. from the battery 48. Alternatively, electrical power may also be supplied to the radiation detection device 44, electronic circuits, etc. of the electronic cassette 28 from the exterior through a cable, without requiring the battery 48 to be accommodated within the casing 40. In this case, the electronic cassette 28 can be made lighter in weight.

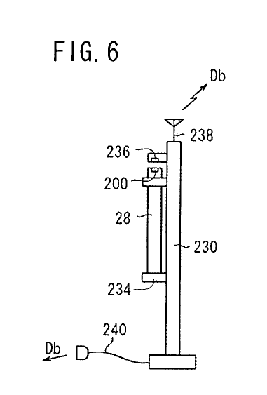

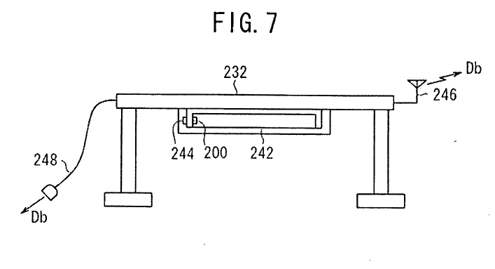

With the above-mentioned example, the infrared light communication unit 200 of the electronic cassette 28 and the first infrared light communication unit 218 of the cradle 30 are made to confront one another, or the infrared light communication unit 200 of the electronic cassette 28 and the second infrared light communication unit 224 of the portable information terminal 32 are made to confront one another, whereby the compressed radiation image information Db is transmitted to the cradle 30 or to the portable information terminal 32. However, apart from this example, as shown in FIGS. 6 and 7, a base 230 or a bed 232 may be used, to which the electronic cassette 28 can be detachably connected.

Specifically, as shown in FIG. 6, a third infrared light communication unit 236 is provided at a portion of the base 230 that faces toward the infrared light communication unit 200 of the electronic cassette 28 when the electronic cassette 28 is placed vertically in an electronic cassette mounting section 234 of the base 230. In addition, the compressed radiation image information Db that is transmitted to the base 230 by infrared light communications with the electronic cassette 28 may be transmitted to the portable information terminal 32 or the cradle 30 by radio waves via an antenna 238. The compressed radiation image information Db may also be transferred to the portable information terminal 32 or the cradle 30 via a cable 240.

Similarly, as shown in FIG. 7, a fourth infrared light communication unit 244 is provided at a portion that confronts the infrared light communication unit 200 of the electronic cassette 28 when the electronic cassette 28 is placed transversely in an electronic cassette mounting section 242 provided underneath the bed 232. In addition, the compressed radiation image information Db, which is acquired by the bed 232 by means of infrared light communications with the electronic cassette 28, may be transmitted to the portable information terminal 32 or the cradle 30 by radio waves via an antenna 246. The compressed radiation image information Db may also be transferred to the portable information terminal 32 or the cradle 30 via a cable 248.

In these examples as well, there is no need to provide a circuit in the electronic cassette 28 for the purpose of transmitting and receiving radio waves, the adverse influence of radio waves is not imparted, and required image information can be acquired and confirmed in a rapid manner.

Of course, the present invention is not limited to the above-described embodiments, and the invention can be freely modified, within a range that does not deviate from the essence and gist of the present invention.

For example, the radiation detection device 44 accommodated in the electronic cassette 28 converts the radiation dose of the irradiated radiation X directly into electric signals through the photoelectric conversion layer 64 (direct conversion type). However, in place of this structure, a radiation detection device (indirect conversion type) in which irradiated radiation X is converted initially into visible light by a scintillator, and thereafter, the visible light is converted into electric signals using a solid-state detector element formed from amorphous silicon (a-Si) or the like, may also be used (see, Japanese Patent No. 3494683).

Further, the radiation image information can be obtained using a radiation detection device of light readout type. With such a light readout type of radiation detection device, radiation is irradiated onto respective solid state detection elements arranged in a matrix form, and an electrostatic latent image corresponding to the irradiation dose is stored cumulatively in the solid state detection elements. When the electrostatic latent image is read, reading light is irradiated onto the radiation detection device, and the generated current values are acquired as radiation image information. Further, by irradiating the radiation detection device with erasing light, the radiation image information in the form of a residual electrostatic latent image can be erased and the radiation detection device can be reused (see, Japanese Laid-Open Patent Publication No. 2000-105297).

Furthermore, a stimulable phosphor panel can also be used as the radiation detection device 44.

What is claimed is:

1. A radiation detection apparatus including a casing, and a radiation detection device accommodated inside the casing, which detects radiation emitted from a radiation source and having passed through a subject, and converts the radiation into radiation image information, further comprising:
a data compression circuit, which compresses the radiation image information to thereby create compressed radiation image information; and
an infrared light communication unit, which converts the compressed radiation image information into an infrared light signal and outputs the infrared light signal.

2. A radiation image capturing system having a radiation detection apparatus including a casing, a radiation detection device accommodated inside the casing, which detects radiation emitted from a radiation source and having passed through a subject, and converts the radiation into radiation image information, and an electronic circuit accommodated inside the casing,
the radiation detection apparatus comprising a data compression circuit, which compresses the radiation image information to thereby create compressed radiation image information, and an infrared light communication unit, which converts the compressed radiation image information into an infrared light signal and outputs the infrared light signal,
and the radiation image capturing system further comprising:
a signal receiving unit for receiving the infrared light signal output from the infrared light communication unit, and converting the infrared light signal into the compressed radiation image information; and
a display unit for displaying the compressed radiation image information from the signal receiving unit.

3. The radiation image capturing system according to claim 2, wherein:
in the radiation detection apparatus, a battery for supplying power at least to the radiation detection device and the electronic circuit is accommodated inside the casing; and
among the signal receiving unit and the display unit, at least the display unit is disposed on a cradle, which carries out charging with respect to at least the battery by mounting of the radiation detection apparatus in the cradle.

4. The radiation image capturing system according to claim 2, wherein:
among the signal receiving unit and the display unit, at least the display unit is disposed on a portable information terminal, which is carried by a user.
